(19) United States
(12) Patent Application Publication
(10) Pub. No.: US 2021/0039792 A1
(43) Pub. Date: Feb. 11, 2021

(54) Trash receptacle attached to airplane fold down tray table

(71) Applicant: Brian James Morrissey, Evansville, IN (US)

(72) Inventor: Brian James Morrissey, Evansville, IN (US)

(21) Appl. No.: 16/602,124

(22) Filed: Aug. 8, 2019

(51) Int. Cl. B64D 11/06; B65F 1/00; B65F 1/14

(52) U.S. Cl. CPC B64D 11/0638; B65F 1/1415; B65F 1/0006

(57) ABSTRACT

This innovation provides access to a non intrusive, personal trash collection receptacle, for use by an airline passenger during a flight. This is provided by the placement of a flexible plastic storage bag, located and connected to a fold down tray table hinge mechanism incorporated within a seat back on the aircraft.

Such a storage bag may be attached to a cooler, or ice chest to provide hikers with a convenient way to temporarily store trash for responsible disposal.

### BACKGROUND OF THE INVENTION

Normally accumulated trash is provided with a source of disposal. Receptacles are generally available that provide access for the storage and disposal of trash. Trash containers are found at home, at work, and in public spaces making disposal convenient. Certain special circumstances exist, where a trash receptacle is needed, but unavailable.

One such location is while seated in an airplane. Restricted space of the configuration of most airline seats preclude the access to trash containers while sitting. Typically a passenger is provided with a fold down tray table, positioned on the back of the seat in front. While in flight, the airlines provide various snacks or meals, or the passenger may have personal items that over the time of a flight generate trash consisting of wrappers, containers, drinking cups, papers and the like accumulating on the tray table. While the airline staff endeavor to collect such trash, passengers are faced with long periods of inconvenience with the tray table in a lowered position waiting for the trash to be collected. Consider being served a meal set up on the limited space available on a tray table.

Several containers of food, along with eating utensils, napkins, wrappers, a bread roll and a drink are placed on the tray table. Each of these items are covered with protective covering that has to be removed and stored on the very limited space available on the tray table, and among the items making up the meal. The covering on the entrée or desert containers may have traces of gravy or sauce residue that requires special attention. The problem facing the passenger is where to store the accumulating trash while eating. If accompanied by a child or elderly person who need help, the problem is made worst.

Unfortunately, some passengers place items of the trash into a lower pocket provided on the seat back containing safety instructions. Several studies have found the tray table, and the lower pocket contain high levels of bacteria, posing health concerns.

The passenger's conditions above are temporary, a final trash collection is provided by airline staff prior to landing. However, in the interim time period, which could be considerable, an additional inconvenience is added to the cramped, restrictive seating conditions by the presence of trash on the tray table, and the inability to dispose of it. This restricts the use of the tray table to provide a surface to work on, or perform other tasks as a passenger would wish.

Other locations not served well with trash disposal is the outdoors, away from established trails and locations. Off the ‘beaten track’ hikers enjoy the countryside, lakes or beaches and take supplies of refreshments with them. Often these are carried in a cooler, or ice chest.

Such remote locations are not served with convenient trash receptacles, and responsible hikers must find other methods to collect and dispose of trash.

### SUMMARY OF THE INVENTION

Accordingly, the benefits provided by a temporary, personal trash receptacle, located in close proximity to a seated passenger, and serves to store accumulated trash during the duration of a flight, is provided. Storage bags made from a suitable, flexible plastic material, available in a variety of sizes, are well known and established, and used to contain various items. Storage bags are fitted with a closure mechanism along a top edge, providing an open or closed option. Such storage bags are therefore provided having extensions included, located along a top edge on either side of the storage bag, terminating in attachable ends.

With the tray table deployed in a lowered position, the attachable ends, each having a free end, and a fixed end, are looped around the tray table hinge members each side. The free ends of the attachable ends are joined together at the fixed ends, suspending and securing the bag between opposing tray table hinges. The bag is now positioned vertically in a space between the seat back, and the trailing edge of the tray table. Access to this bag is available to open, place items within, and re-close the bag. With the tray table repositioned to a closed, vertical position, the bag is located in a position under the tray table assembly, falling against the seat back proper, accessible for use, yet positioned not to intrude into the passengers space.

Several aspects of the embodiment below illustrate various functions or methods, and are not intended to be limiting on the present invention. Like numerals refer to like parts through the drawings. The present invention provides access to a non intrusive, personal trash collection receptacle, for use by an airline passenger during a flight. This is provided by the placement of a flexible plastic storage bag, located and connected to a fold down tray table hinge mechanism incorporated within a seat back on the aircraft.

### BRIEF DESCRIPTION IF THE DRAWINGS

FIG. 1. is a frontal view of a flexible storage bag including an extension fitted each end, located near a top edge of the bag.

FIG. 2. Is a detail of an extension indicating a cross section of an enclosed table tray structure.

FIG. 3. is a detail of an extension indicating a different cross section of an enclosed table tray structure.

FIG. 4. is a variation of an extension attachment showing a closing method.

FIG. 5. is a perspective view of the back of an airplane seat, illustrating a table tray in a lowered position, showing a storage bag attached and suspended from the table tray hinge mechanism.

FIG. 6. Is a rear view of a bar member, with an extension included each end, with a view showing a bag suspended from it.

FIG. 7. is a view of a portion of a table tray hinge mechanism indicating an attachment to a storage bag.

FIG. 8, and FIG. 9. show different attachment hanger structures.

FIG. 10. is a perspective view of an ice chest container, showing a storage bag location.

FIG. 11. shows a bar member including two attachment hangers, including a storage bag attachment method.

### DETAILED DESCRIPTION OF THE INVENTION

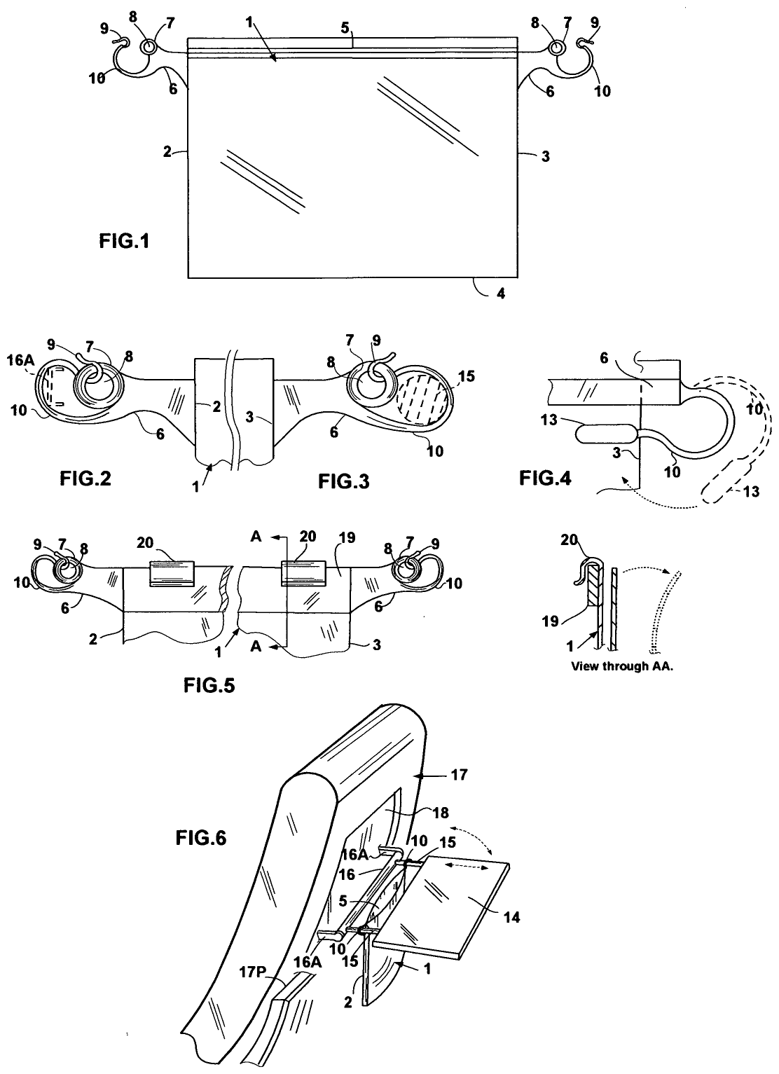

Referring now to more details of the invention. A flexible, plastic storage bag FIG. 1. 1 is fitted at a top edge with an opening and closing device 5, and is fitted on each side, with an extension 6. FIG. 2 and FIG. 3 detail extension 6, and free end attachments 10, that are looped around portions of a tray table assembly's hinge mechanism, 15, or 16A that vary in design. 15 and 16A. are broken line cross sectional representative of two such members. Hook 9, is inserted through hole 8, in receiver 7, with free end 10, being stretched to impart tension to suspend storage bag 1. between two opposing ends of the tray table hinge members.

An alternative attachment is shown in FIG. 4. whereby free end attachment 10, terminates in member 13, having adhesive on one side, of the ‘peel and stick’ type, that, when looped around the table tray, 15. or 16A, is attached to the storage bag 1, proper, securing the bag in one instance, and removing it in another.

Details of the storage bag attachment to the tray table hinge members are explained by turning to FIG. 6. The tray table 14 may be located in an upright, stored position within recess 18, of seat 17, or lowered into a deployed horizontal position as shown. Tray tables are fitted with various types of hinge arrangements, depending on the aircraft type, but basically result in a distance between the seat back recess 18, and the trailing edge of the tray 14. In addition to hinges, some trays tables slide from a closed up position, to an opened up position, increasing the distance between the seat back and trailing edge of the tray table 14 and hinge members 16, and 16A. by using sliding supports 15.

The distance between seat recess 18, and tray 14, provide an unobtrusive area, readily available, in close proximity to a passenger. By attaching the storage bag 1. in this area, suspended and tensioned between slide supports 15 on either side, gives access to the top portion of the storage bag, 1 to open, insert trash, and close, 5, freeing up the limited space available on the tray table 14, and providing the passenger an option of a clear tray table. Hinge element 16, may also provide attachment points.

With the tray returned to an upright position, within recess 18, the storage bag, 1, suspended as described, hangs down against the seat back 17, and covers a portion of a lower pocket 17P. In this position access to the contents of the lower pocket 17P are available by lifting the lower edge 4 of storage bag 1, rotating away from the lower pocket. Covering the top portion of the lower pocket 17P will serve to discourage using this lower pocket for trash collection, and will result in less bacteria accumulating and diminish health concerns. By providing this storage bag 1, to passengers, the cleaning crews are presented with less trash placed in the lower pocket, thereby saving time in having to deal with it and the concern of bacteria present.

Another embodiment, shown in FIG. 5, illustrates storage bag 1 as single member, having two hook like extensions 20, placed near the top edge of the storage bag 1. Supporting member 19, is a narrow plastic strip, rigid in a vertical direction, attached to the tray table hinge mechanism in a manner described above, In this instance the storage bag 1, is attached to supporting member 19, by hook members 20 being placed over supporting member 19, shown as viewed from the rear, in view AA.

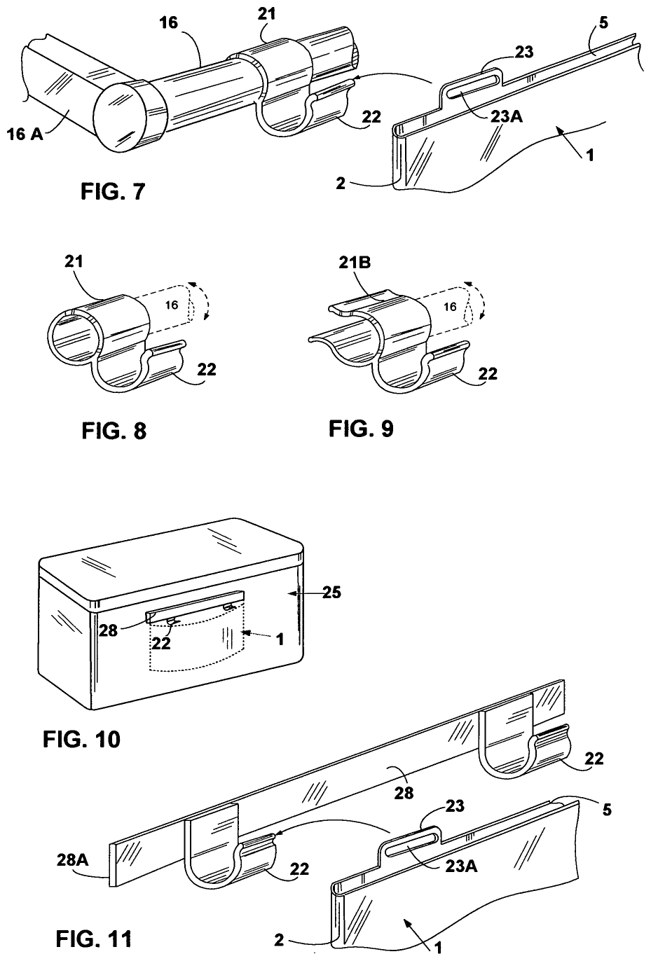

Yet another embodiment describes different attachment methods. FIG. 7, shows hinge mechanism 16. incorporating a swiveling member 21, and attached hanger member 22. This represents a permanent item incorporated in the tray table hinge mechanism as manufactured, and is detailed in FIG. 8. The design of storage bag 1 would contain top edge extension receivers 23, having slot 23A, placed over hanger 22. to secure storage bag 1. FIG. 9 shows the above with the item 21B available to snap over member 16 and swivel. In the above embodiments removal of the storage bag 1 is achieved by separating the attachments from the tray table hinge members.

Addressing the aforementioned use of coolers, or ice chests, FIG. 10 illustrates such an item, 25. Placement of a storage bag 1, is shown in broken line, placed at a convenient location on the side of the cooler. 25, In FIG. 11 attachment is shown by way of a plastic supporting member 28, having a front and a back. The front is fitted with two hanger items 22, and the back has an adhesive coating, 28A, that may be of the “peel and stick” type, and is attached to cooler 25. Storage bag 1 is fitted with top edge extension receivers 23, having slot 23A, placed over hanger 22. to secure storage bag 1 as previously mentioned.

Several attachment methods have been illustrated to connect storage bag 1 to the hinge mechanisms of the tray table, those skilled in the art will recognize additional attachments methods are available

What is claimed is:

1. A trash receptacle, for storing items, comprising;
A re-sealable plastic storage bag, attached and suspended from a tray table device, located on a passenger seat on an airplane, included on each end of the storage bag a lateral extension located near a top edge, each extension including one fixed and one free attachable end, wherein;

2. the trash receptacle of claim 1, having the fixed and free attachable ends coupled together, providing a securing method to attach a storage bag temporarily to a tray table hinge mechanism;

3. the trash receptacle of claim 2, where attachable ends may be un-coupled to remove the storage bag from the tray table hinge mechanism;

4. the trash receptacle of claim 1, where access to the storage bag is available whether the tray table is positioned in a deployed, horizontal position, or upright, locked position;

5. the trash receptacle of claim 1, whereas accumulated trash is contained within the storage bag, over the duration of a flight;

6. the trash receptacle of claim 1, is located within easy reach of a seated passenger, but does not intrude into a passenger's space;

7. a trash receptacle, for storing items, comprising;
a re-sealable plastic storage bag, attached to a container for the preservation of foodstuff, such as a cooler or ice chest, including a lateral supporting bar, having a front side, and a back side, the front side containing a plurality of hook attachments, and the back side having a covered adhesive prepared surface;
whereas;

8. a trash receptacle of claim 7, the supporting bar adhesive face is uncovered and attached to a convenient location on a cooler;

9. a trash receptacle of claim 7, whereby the plastic storage bag is attached to, and removed, from the hooks.
